(19) United States
(12) Patent Application Publication
(10) Pub. No.: US 2003/0170514 A1
(43) Pub. Date: Sep. 11, 2003

(54) Fuel cell device

(76) Inventors: Ian Faye, Stuttgart (DE); Frank Brenner, Remseck (DE); Hans-Ruediger Weiss, Stuttgart (DE); Thanh-Hung Nguyen-Schaefer, Asperg (DE); Rainer Saliger, Freiberg (DE); Thomas Hebner, Stuttgart (DE)

Correspondence Address: STRIKER, STRIKER & STENBY, 103 East Neck Road, Huntington, NY, 11743, US

(21) Appl. No.: 10/367,347

(22) Filed: Feb. 14, 2003

(30) Foreign Application Priority Data
Sep. 30, 2002 (DE) 102 45 660.7
Feb. 15, 2002 (DE) 102 06 238.2

(51) Int. Cl. H01M 8/06; H01M 8/02

(52) U.S. Cl. 429/19; 429/34

(57) ABSTRACT

A fuel cell device has a fuel cell unit, a conversion unit for converting material mixtures to a hydrogen-containing fluid stream, a separation device for separating at least one hydrogen-enriched material stream from a fluid residual stream, the separation device being formed as a mass separation device for separating different masses.

### BACKGROUND OF THE INVENTION

The present invention relates generally to fuel cell devices.

More particularly, it relates to a fuel cell device with a fuel cell unit and a conversion unit for converting fuel mixtures into a hydrogen-containing fluid stream.

In known fuel cell devices frequently in particular hydrocarbon-containing material mixtures are converted by a reformation and the like to a hydrogen-containing fluid stream or reformate. The thusly produced hydrogen in the fuel cell unit first of all is converted into electrical current and it is utilized for driving electric motors or for operating similar electrical consumers. Corresponding systems are used for example in vehicles for driving and/or for operation of numerous electrical consumers.

In addition to hydrogen these systems also produce bi-products such as carbon monoxide or carbon dioxide. Carbon monoxide is damaging for modern common fuel cell units in general, so that it is converted into carbon dioxide by corresponding cleaning devices. The fluid stream which is supplied to the fuel cell unit has a relatively high portion of carbon dioxide which is not utilized by the fuel cell unit. Common fuel cell units can not convert hydrogen contained in the fluid stream completely, so that the discharge stream of the fuel cell unit has a certain portion of hydrogen. A circulation or recirculation of the discharge stream back into the fuel cell unit counteracts the relatively high carbon dioxide portion, since it significantly increases within short time and thereby undesirably affects the operation of the fuel cell unit or the current generation.

U.S. Pat. No. 6,063,515 discloses the use of a separator or a separating device, for separating the carbon dioxide or the hydrogen from a residual stream. Thereby a circulation of the discharge stream which flows out of the fuel cell unit is possible. This known separating device or separating unit has a diaphragm. The disadvantage is that the relatively high operational and structural expenses and also relatively high pressure for acting on the diaphragm are involved.

### SUMMARY OF THE INVENTION

Accordingly, it is an object of the present invention to provide a fuel cell device with a fuel cell unit, a conversion unit for converting material mixtures to a hydrogen-containing fluid stream and separating device for separating at least one hydrogen-enriched material stream from a fluid stream, which reduces the expenses when compared with the known fuel cell devices.

In keeping with these objects and with others which will become herein after, one feature of the present invention resides, briefly stated in a fuel cell device which has a fuel cell unit; a conversion unit for converting material mixtures to a hydrogen-containing fluid stream; a separation device for separating at least one hydrogen-enriched material stream from a fluid residual stream, said separation device being formed as a mass separation device for separating different masses.

The fuel cell device in accordance with the present invention is characterized in that the separating device is formed as a mass separating device for separating various masses.

With the mass separating device in accordance with the present invention it is possible to separate a relatively lighter (with respect to its mass) hydrogen-containing material stream from a relatively heavier (with respect to its mass fluid stream), in particular CO₂-containing fluid stream, without high expenses. It is possible to perform at least partially the separation of the streams with the use of the force of gravity or the like. For example, the generation of a relatively high pressure action of the fluid stream as used in the prior art can be dispensed with.

The mass separation device preferably has at least one deviating element for deviating the fluid stream. The fluid stream has advantageously a relatively high flow speed. Thereby a radial acceleration of the fluid stream or reformate is provided, so that a separation can be performed due to the differently higher molecular weight and the resulting different centrifugal forces.

In some cases the mass separation device with the deviating element is arranged in the flow direction behind the fuel cell unit. Preferably the inventive mass separation device with the deviation unit is arranged between the converting unit and the fuel cell unit or in the flow direction behind a so-called “shift-stage”, since the fluid stream in this region has a relatively high and substantially continuous flow speed.

The deviating element can be advantageously formed as a circular arc element. A correspondingly shaped tubular circular arc element can have an advantageous radius of curvature for a centrifugal acceleration of the fluid stream.

In a preferable further embodiment of the invention, the mass separation device has at least one delay element for delaying the flow speed. Preferably the delay element can be arranged in a flow direction behind the deviating element. With these features it is possible to further improve a partial separation which is obtained in some cases by means of the deviation element, with the use of the delay element.

The delay element preferably has a substantially larger flow cross-section than the deviating element, so that the flow speed of the fluid stream or the material stream/fluid residual stream is substantially reduced when compared with the flow speed in the deviating element. Thereby in a specially simple manner a quieting or delay of the flow speed is obtained. A corresponding delaying or quieting of the streams additionally improves the separation of the hydrogen-containing material stream from the fluid residual stream.

In accordance with an alternative embodiment of the invention, the delay element can be used also without a special deviating element, or in other words without a mass separation by the centrifugal force.

In some cases the mass separation device can be arranged also without the special deviating element in flow direction before the fuel cell unit. Preferably the inventive mass separation device without the special deviating element is arranged behind the fuel cell unit in the fluid direction, since the fluid stream in this region can be quieted relatively simply by the delay element, so that the delay element is formed specifically as the quieting element. For this purpose the fluid stream to be separated has a relatively low fluid speed and/or in an advantageous manner can be stored intermediately or in an advantageous manner can be stopped or intermediately stored by the delay element. In the latter case, an advantageously discontinuous or charge-wise separation of the material stream from the fluid stream or emptying of the delay element are provided.

With the variant of the invention behind the fuel cell unit, a nitrogen in particular introduced by environmental air into the fuel cell unit and diffused through its membrane can be separated from the hydrogen containing material stream. The further utilization or circulation of the hydrogen-containing material stream is hereby substantially improved.

In a further variant of the invention the delay element has a first opening for discharging the hydrogen-enriched material stream and a second opening for discharging the fluid residual stream. Preferably the first opening is arranged vertically above the second opening. In advantageous manner, the second opening is arranged in the vertical direction in the deepest region of the delay element and/or the first opening is arranged in a vertical direction in the highest region of the delay element. With such a construction of the openings or a correspondingly designed delay element, an additional separation of the hydrogen-enriched material stream from the fluid residual stream or residual gas stream, such as for example from carbon dioxide and/or nitrogen material stream can be performed with the assistance of the gravity force or acceleration due to the gravity.

In accordance with a special embodiment of the invention present invention a dosing element is arranged at least on one of the openings, for example on the second opening, for discharging the fluid residual stream, and in some cases on the first opening for discharging the hydrogen-containing material stream. Thereby a withdrawal of the fluid residual stream or the material stream can be regulated without high expenses.

For certain applications, in particular with the arrangement of the mass separation device in the flow direction behind the fuel cell unit, at least one of the dosing elements is formed as a cycle (timing) valve or the like. Thereby a particularly simple conversion of a discontinuous or charge-wise operation of the mass separation device is possible. During a waiting phase the relatively light, hydrogen-containing portion is continuously separated from the heavy residual stream. After the waiting phase it advantageously can flow out or can be released preferably separately from the delay element and/or correspondingly pumped out by a pump or the like. For example the waiting time can be approximately 5-20 minutes or longer.

Advantageously, at least one inflow element is arranged on an inflow opening of the delay element and/or at least one outflow element is arranged on the first and/or second opening. Preferably they are arranged at least partially in the inner region of the delay element. By means of the corresponding inflow or outflow elements, the position of the inflow region and/or the position of the outflow region in the whole inner chamber of the delay element can be exactly determined. For example, by means of the inflow element the inflow region of the fluid stream can be located in the lower portion of the delay element, so that a whirling or mixing in the upper portion of the enriched hydrogen-containing portion is efficiently prevented. Alternatively or in combination with this, the inflow opening of the delay element can be arranged in a lower portion.

In a special embodiment of the invention, the inflow element and/or the outflow element have several passages for inflow or outflow of the stream. Several or numerous passages, through which the fluid can flow in or flow out, increase in advantageous manner the cross-sectional surface of the inflow opening or the outflow opening and provide a relatively low whirling of the stream, so that an advantageous mass separation in accordance with the present invention can be realized.

The inflow element or the outflow element can be composed of a porous material. In some cases, the porous material can be formed by a foam and/or centered material and the like. In some cases the passages can be formed with relatively small throughgoing openings, for example with diameters of less than 100 μm.

By means of one or several above mentioned features, an advantageous depletion primarily of a residual gas, such as for example carbon dioxide, nitrogen, nitrogen oxide and the like from the fluid residual stream or reformate stream is possible. Therefore, in this case the hydrogen-enriched material stream is supplied to the fuel cell unit and after passage of the fuel cell element for further use of the not converted hydrogen, this discharge stream can be supplied again to the fuel cell unit. Thereby a harmful enrichment of carbon dioxide or the like or another gas which is not converted in the fuel cell is prevented in the recirculated material stream.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view schematically showing an inventive separating device with a circular arc;

FIG. 2 is a schematic view of a further embodiment of the inventive separating device;

FIG. 3 is a schematic view of a third embodiment of the separating device with a flow buffer; and

FIG. 4 is a schematic block diagram with a variance of preferable embodiments of the inventive separating device.

### DESCRIPTION OF THE PREFERRED EMBODIMENTS

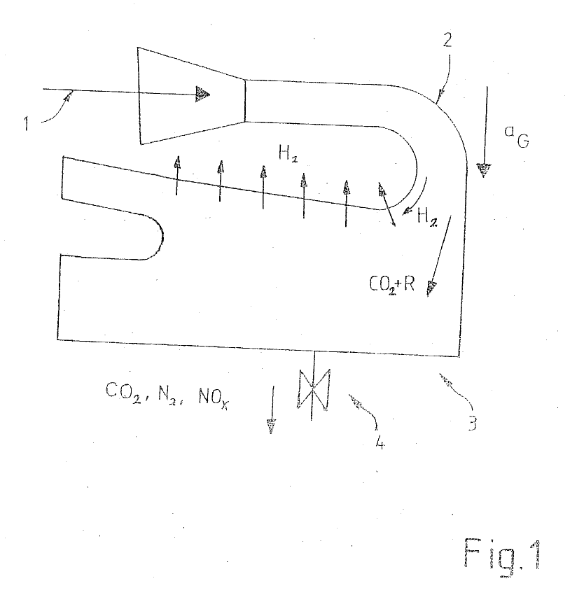

FIG. 1 schematically shows a separating device in accordance with the present invention. A hydrogen-containing fluid stream 1 or reformat which contains in particular carbon dioxide CO₂ and hydrogen H₂ is supplied to the separating device. The fluid stream 1 is deviated by a arched tube 2 or is subjected to the action of a radial acceleration, so that a certain separation of the hydrogen H₂ from carbon dioxide CO₂ and residual gasses R is performed.

A delay element 3 is arranged behind the pipe 2 in the flow direction. Due to the relatively large cross-section the at least one partially separated fluid stream 1 is quieted and with the assistance of the acceleration due to gravity a_{G} and also different curve radii produced by the pipe 2, the different partial streams produced by the tube 2, a separation or suction of the hydrogen H₂ from the residual gasses R as well as for example from carbon dioxide CO₂ is provided. The residual gas R or the carbon dioxide CO₂ are discharged by means of an overpressure valve 4 from the container or delay element 3. The hydrogen stream H₂ is supplied in a not shown manner to fuel cell unit.

A separating device in accordance with the present invention provides separation of the fluid stream 1 due to the different molecular weights of the hydrogen H₂ and the residual gas R or the carbon dioxide CO₂. The curved pipe 2 leads to a radial acceleration of the fluid stream 1 or the reformat gas and advances the separation. Thereby an depletion of the residual gas R or the carbon dioxide CO₂ from the fluid stream 1 is achieved. A recirculation of the material stream H₂ supplied to the fuel cell element is therefore possible, so that the utilization of the hydrogen H₂ contained in the fluid stream 1 is improved.

The separation device shown in FIG. 1 with the arched pipe 2 is arranged in advantageous manner before a fuel cell in the flow direction, since a dislocation relatively high flow speeds occur in the system therefore high centrifugal forces in the rotor 2 guarantee a separation of the relatively light hydrogen H₂ from the relatively heavy residual gas R.

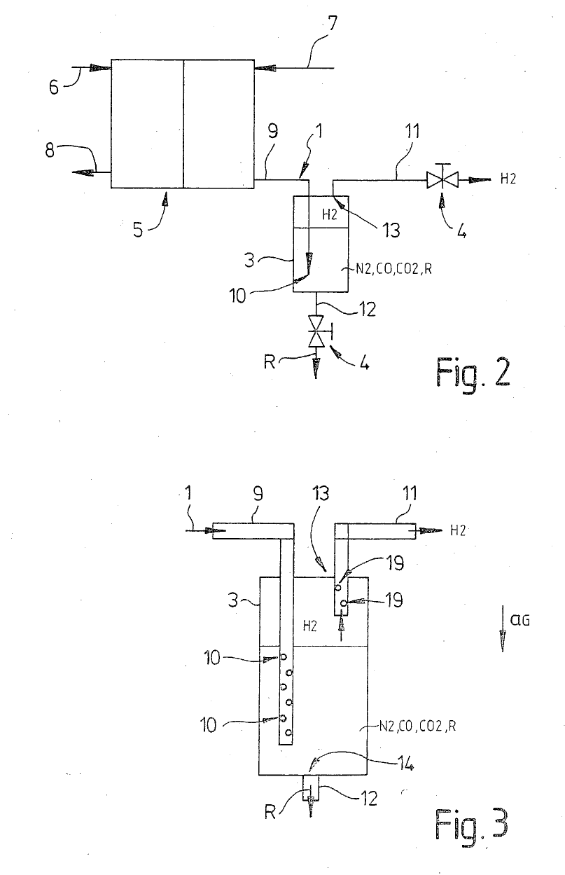

FIG. 2 shows a separation device in accordance with the present invention, which is arranged in the flow direction behind a fuel cell 5. The fuel cell 5 is supplied with air 6 and a hydrogen-rich fluid stream 7 or a reformat 7 of a not shown reformer. Between the fuel cell 5 and the not shown reformer, cleaning devices which are formed as known in the art can be provided in a not shown manner.

A hydrogen containing stream 8 as well as the fluid stream 1 flows out of the fuel cell 5 at a cathode side. The fluid stream 1 in accordance with the present invention is separated by the delay element 3 or the quieting element into a hydrogen stream H₂ and residual gas stream R.

A conduit 9 is arranged between the delay element 3 and the fuel cell 5. The conduit 9 ends preferably in a lower region of the delay element 3 or extends correspondingly into it. Therefore an inflow region 10 is located in the vicinity of the container bottom. Due to the significant differences in the molecular masses or the great density differences between the hydrogen H₂ and the residual gas R, the residual gas R lowers and the hydrogen H₂ “floats” in the upper portion of the container or the delay element 3.

The valves 4 shown in FIG. 2 are preferably cycle (timing) valves 4 for example after a waiting time of approximately 20 minutes they are actuated or open. Thereby hydrogen H₂ flows through a conduit 11 into a not shown collecting container or in some cases back to the fuel cell 5. A flow out opening 14 is located at the highest point of the container 3, so that approximately clean hydrogen H₂ is withdrawn from the container 3 by the conduit 11 and preferably is supplied back to the anode of the fuel cell 5.

For releasing the residual gas R into the atmosphere, the cycle valve 4 opens a conduit 12. A flow out opening 14 is provided in particular at the deepest point of the container 3, so that the residual gas R can flow out into the conduit 12.

FIG. 3 schematically shows a further embodiment of the present invention. In contrast to the delay element 3 of FIG. 2, the delay element or the container 3 in FIG. 3 has an inflow conduit for the fluid stream 1 and an outflow conduit 11 for releasing of approximately clean hydrogen H₂. The both conduits 9, 11 have a plurality of small passages 10, 19. Thereby, in an advantageous manner, the through surface 4 inflowing or outflowing gas 1, H₂ is significantly increased. Therefore a whirling in the delay element 3 is efficiently prevented. These features lead to an especially advantageous separation in accordance with the present invention. In some cases, the outflow opening 14 has not shown small passages which correspond to the passages 10, 19.

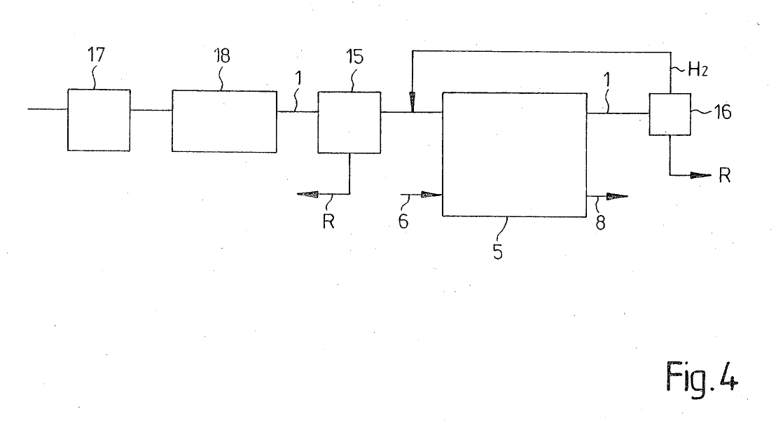

FIG. 4 shows the block diagram of the fuel cell device with a mass separation device 15, 16 in accordance with the present invention. The fuel cell device includes for example a reformer 17 and in some cases a shift unit 18 arranged behind it in the flow direction. It is provided for cleaning of the reformat produced by the reformer 17 and can have for example several cleaning stages.

Optionally the mass separation device or the separator 15 is arranged behind the reformer 17 in the flow direction. The separator 15 substantially corresponds to the device of FIG. 1. In other words the separator 15 has a pipe 2.

The fuel cell 5 is arranged behind the separation 15 in the flow direction. It contains a relatively clean hydrogen H₂ and also air 6.

The water vapor containing stream 8 at the cathode as well as the fluid stream 1 at the anode side from the educt streams are in the fuel cell 5. The separator 16 is provided optionally. The hydrogen stream H₂ of the separator 16 is converted preferably further as the educt stream of the fuel cell 5. In some cases the hydrogen stream H₂ of the separator 16 can be provided for other applications. The separator 16 substantially corresponds to the mass separation device of FIGS. 2 or 3.

It will be understood that each of the elements described above, or two or more together, may also find a useful application in other types of constructions differing from the types described above.

While the invention has been illustrated and described as embodied in fuel cell device, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A fuel cell device, comprising a fuel cell unit; a conversion unit for converting material mixtures to a hydrogen-containing fluid stream; a separation device for separating at least one hydrogen-enriched material stream from a fluid residual stream, said separation device being formed as a mass separation device for separating different masses.

2. A fuel cell device as defined in claim 1, wherein said mass separation device has at least one deviating element for deviating the fluid stream.

3. A fuel cell device as defined in claim 2, wherein said deviating element is formed as a circular arc element.

4. A fuel cell device as defined in claim 2, wherein said mass separation device has at least one delay element for delaying a flow speed.

5. A fuel cell device as defined in claim 4, wherein in a region of said delay element a substantially greater flow cross-section is provided then in a region of said deviating element.

6. A fuel cell device as defined in claim 4, wherein said delay element has a first opening for flowing out of the hydrogen-enriched material stream and a second opening for flowing out of the fluid residual stream.

7. A fuel cell device as defined in claim 6, wherein said first opening is arranged in a vertical direction above said second opening.

8. A fuel cell device as defined in claim 6, wherein said second opening is arranged in a vertical direction in a deepest region of said delay element.

9. A fuel cell device as defined in claim 6; and further comprising a dosing element arranged in at least one of said openings.

10. A fuel cell device as defined in claim 9, wherein said dosing element is formed as a cycle valve.

11. A fuel cell device as defined in claim 11; and further comprising at least one element selected from the group consisting of an inflow element and an outflow element associated with said delay element.

12. A fuel cell device as defined in claim 11, wherein said delay element has an inflow opening, said inflow element being arranged on said inflow opening.

13. A fuel cell device as defined in claim 11, wherein said outflow element is arranged on said first opening.

14. A fuel cell device as defined in claim 11, wherein said outflow element is arranged on said second opening.

15. A fuel cell device as defined in claim 1, wherein said at least one element is arranged at least partially in an inner region of said delay element.

16. A fuel cell device as defined in claim 11, wherein said at least one element has a plurality of passages for an inflow and an outflow of the streams correspondingly.
